(19) United States
(12) Patent Application Publication
(10) Pub. No.: US 2008/0055198 A1
(43) Pub. Date: Mar. 6, 2008

(54) METHOD OF DRIVING PLASMA DISPLAY DEVICE FOR REDUCING POWER CONSUMPTION

(76) Inventor: Sang-Shin Kwak, Yongin-si (KR)

Correspondence Address: CHRISTIE, PARKER & HALE, LLP, PO BOX 7068, PASADENA, CA, 91109-7068, US

(21) Appl. No.: 11/696,678

(22) Filed: Apr. 4, 2007

(30) Foreign Application Priority Data
Sep. 6, 2006 (KR) 10-2006-0085655

(51) Int. Cl. G09G 3/28

(52) U.S. Cl. 345/60; 345/211

(57) ABSTRACT

A driving method of a plasma display device for reducing power consumption is provided. In the driving method of the plasma display device, a discharge current, which is consumed during a period where a voltage of a first electrode is increased and maintained through an inductor in a sustain discharge circuit, is induced to flow to a capacitor of an energy recovery circuit connected to a second electrode, thereby recovering discharge power. Accordingly, power consumed during a sustain discharge period can be reduced.

### CROSS-REFERENCE TO RELATED APPLICATION

This application claims priority to and the benefit of Korean Patent Application No. 10-2006-0085655, filed in the Korean Intellectual Property Office on Sep. 6, 2006, the entire content of which is incorporated herein by reference.

### BACKGROUND OF THE INVENTION

(a) Field of the Invention

The present invention relates generally to a method of driving a plasma display device for reducing power consumption, and more particularly to an energy recovery circuit of a plasma display device.

(b) Description of the Related Art

A plasma display device is a device configured to display characters or images thereon using plasma generated by gas discharge. A plasma display panel (PDP) includes several hundreds of thousands to millions of discharge cells arranged in a matrix format depending on its size.

In general, in the plasma display device, one frame is driven while being divided into a plurality of subfields. Grayscale is represented by a combination of weight values of subfields in which a display operation occurs, of the plurality of subfields. During the address period of each subfield, cells to be turned on (“on-cells”) and cells not to be turned on (“off-cells”) are selected. During the sustain period, sustain discharge is performed on cells to be turned on in order to display an actual image.

In order for this operation to be performed, a high level voltage and a low level voltage are alternately applied to electrodes that perform the sustain discharge during the sustain period. Two electrodes in which the sustain discharge is generated function as capacitive components, and they induce a discharge current that is applied when the high level voltage is applied to the electrodes, to a ground terminal, thus applying the low level voltage.

A typical sustain discharge circuit and driving method thereof will be described below with reference to FIGS. 1 and 2.

FIG. 1 is a schematic circuit diagram of a typical sustain discharge circuit, and FIG. 2 is a signal timing diagram of the typical sustain discharge circuit.

In the typical sustain discharge circuits 10 and 20 shown in FIG. 1, one X electrode X and one Y electrode Y are illustrated for better understanding and ease of description. Capacitive components formed by the X electrode X and the Y electrode Y are indicated by “panel capacitor Cp”.

As shown in FIG. 1, the sustain discharge circuit 10 includes transistors Sxr, Sxf, Sxs, and Sxg, an inductor Lx, diodes Dxr, Dxf, Dx1, and Dx2, and a capacitor Cx. The sustain discharge circuit 20 includes transistors Syr, Syf, Sys, and Syg, an inductor Ly, diodes Dyr, Dyf, Dy1 and Dy2, and a capacitor Cy.

Each of the sustain discharge circuit 10 and the sustain discharge circuit 20 alternately applies a voltage Vs and 0V to the sustain electrode X or the scan electrode Y of the panel capacitor Cp. This will be described by reference to the signal timing diagram of FIG. 2.

It is first assumed that before a first mode M1 operates, the transistor Sxg and the transistor Syg are turned on to apply 0V to the sustain electrode X and the scan electrode Y.

In the first mode M1, the transistor Sxr and the transistor Syg are turned on, and the remaining transistors Sxf, Sxs, Sxg, Syr, Syf, and Sys are turned off. Due to this, a voltage Vx of the sustain electrode X rises up to the Vs voltage. Meanwhile, a voltage Vy of the scan electrode Y is kept at 0V since the transistor Syg is turned on.

In a second mode M2, two transistors Sxs and Syg are turned on, and the remaining transistors Sxr, Sxf, Sxg, Syr, Syf, and Sys are turned off. Due to this, the voltage Vx of the sustain electrode X is maintained at the Vs voltage. At this time, the voltage Vy of the scan electrode Y is maintained at 0V since the transistor Syg is turned on.

In a third mode M3, two transistors; the transistors Sxf and Syg are turned on, and the remaining transistors Sxr, Sxs, Sxg, Syr, Syf, and Sys are turned off. Due to this, the voltage Vx of the scan electrode X falls from the Vs voltage to 0V, and the voltage Vy of the scan electrode Y is maintained at 0V since the transistor Syg is turned on.

In a fourth mode M4, two transistors Sxg and Syg are turned on, and the remaining transistors Sxr, Sxf, Sxs, Syr, Syf, and Sys are turned off. Due to this, the voltage Vx of the sustain electrode X and the voltage Vy of the scan electrode Y are maintained at 0V.

In a fifth mode M5, two transistors Sxg and Syr are turned on, and the remaining transistors Sxr, Sxf, Sxs, Syf, Sys, and Syg are turned off. Due to this, the voltage Vy of the scan electrode Y rises up to the Vs voltage. At this time, the voltage Vx of the sustain electrode X is maintained at 0V since the transistor Sxg is turned on.

In a sixth mode M6, two transistors Sxg and Sys are turned on, and the remaining transistors Sxr, Sxf, Sxs, Syr, Syf, and Syg are turned off. Due to this, the voltage Vy of the scan electrode Y is maintained at the Vs voltage. At this time, the voltage Vx of the sustain electrode X is maintained at 0V since the transistor Sxg is turned on.

In a seventh mode M7, two transistors Sxg and Syf are turned on, and the remaining transistors Sxr, Sxf, Sxs, Syr, Sys, and Syg are tuned off. Due to this, the voltage Vy of the scan electrode Y drops from the Vs voltage to 0V. Meanwhile, the voltage Vx of the sustain electrode X is maintained at 0V since the transistor Sxg is turned on.

In an eighth mode M8, two transistors Sxg and Syg are turned on, and the remaining transistors Sxr, Sxf, Sxs, Syr, Sys, and Syf are turned off. Due to this, the voltage Vx of the sustain electrode X and the voltage Vy of the scan electrode Y are maintained at 0V.

The method of driving the typical sustain discharge circuit, which includes the first to eighth modes M1 to M8, can reduce power consumption during a period in which the sustain discharge operation is performed. However, power consumption during the sustain discharge operation is still large. Accordingly, there is an increasing need for a method of driving the sustain discharge circuit in such a way to further reduce power consumption in accordance with a current trend toward requiring lower power consumption and higher circuit integration.

The above information disclosed in this Background section is only for enhancement of understanding of the background of the invention and therefore it may contain information that does not form the prior art that is already known in this country to a person of ordinary skill in the art.

### SUMMARY OF THE INVENTION

In one exemplary embodiment of the present invention, a method of driving a plasma display device is provided. The method reduces power consumption in such a way that in a period where a discharge current increases and then decreases during the sustain period of a PDP, the discharge current is induced to flow through a capacitor of an energy recovery circuit, thereby recovering discharge power without a significant change in a panel voltage.

In an exemplary embodiment according to the present invention, a method of driving a plasma display device is provided. The plasma display device includes first and second electrodes forming a panel capacitor, a first power supply for supplying a first voltage, a second power supply for supplying a second voltage, first and second inductors having respective first ends connected to the first and second electrodes, respectively, and first and second capacitors electrically coupled to respective second ends of the first and second inductors, respectively, wherein the first and second voltages are alternately applied to the first and second electrodes. The method includes: allowing a first current to flow along a first current path including the first capacitor, the first inductor, the panel capacitor, and the second power supply, thereby changing a voltage of the first electrode from the second voltage to the first voltage and maintaining a voltage of the second electrode at the second voltage; allowing a second current to flow along a second current path including the first power supply, the panel capacitor, and the second power supply, thereby maintaining the voltages of the first and second electrodes at the first and second voltages, respectively; allowing a third current to flow along a third current path including the first power supply, the panel capacitor, the second inductor and the second capacitor, thereby charging the second capacitor; and allowing a fourth current to flow along a fourth current path including the panel capacitor, the first inductor and the first capacitor, thereby charging the first capacitor while changing the voltage of the first electrode from the first voltage to the second voltage.

In another exemplary embodiment according to the present invention, a method of driving a plasma display device is provided. The plasma display device includes first and second electrodes forming a panel capacitor, first and second charge switches configured to provide charge paths to the first and second electrodes, respectively, first and second discharge switches configured to provide discharge paths to the first and second electrodes, respectively, first and second switches connected to a first power supply and configured to supply a first voltage to the first and second electrodes, respectively, third and fourth switches connected to a second power supply and configured to apply a second voltage to the first and second electrodes, respectively, and first and second capacitors having respective first ends connected to the first charge and discharge switches and the second charge and discharge switches, respectively, and respective second ends connected to the second power supply, wherein the first and second voltages are alternately applied to the first and second electrodes. The method includes: turning on the first charge switch and the fourth switch, thereby changing a voltage of the first electrode from the second voltage to the first voltage and maintaining a voltage of the second electrode at the second voltage; turning off the first charge switch and turning on the first switch, thereby maintaining the voltages of the first and second electrodes at the first and second voltages, respectively; turning off the fourth switch and turning on the second discharge switch, thereby charging the second capacitor; and turning off the first switch and the second discharge switch and turning on the first discharge switch and the fourth switch, thereby charging the first capacitor while changing the voltage of the first electrode from the first voltage to the second voltage.

In yet another exemplary embodiment according to the present invention, a method of driving a plasma display device is provided. The plasma display device includes first and second electrodes forming a panel capacitor, a first power supply for supplying a first voltage to the first electrode, a first switch having a first end connected to the second electrode and a second end connected to a second power supply for supplying a second voltage, an inductor having a first end connected to a contact point between the second electrode and the first switch, a second switch having a first end electrically coupled to a second end of the inductor, and a capacitor having a first end electrically coupled to a second end of the second switch and a second end connected to the second power supply. The method includes: turning on the first switch and turning off the second switch so that current flows along a first current path including the first power supply, the panel capacitor, and the second power supply, thereby maintaining voltages of the first and second electrodes at the first and second voltages, respectively; and turning off the first switch and turning on the second switch so that current flows along a second current path including the first power supply, the panel capacitor, the inductor, the capacitor, and the second power supply, thereby charging the capacitor.

### BRIEF DESCRIPTION OF THE DRAWINGS

FIG. 1 is a schematic circuit diagram of a typical sustain discharge circuit;

FIG. 2 is a signal timing diagram of the typical sustain discharge circuit of FIG. 1;

FIG. 3 is a block diagram showing a plasma display device according to an exemplary embodiment of the present invention;

FIG. 4 is a signal timing diagram of a sustain discharge circuit according to an exemplary embodiment of the present invention;

FIGS. 5A to 5J are circuit diagrams showing the operation of the sustain discharge circuit according to the signal timing of FIG. 4; and

FIG. 6 is an electrical equivalent circuit diagram in a first discharge power recovery period according to an exemplary embodiment of the present invention.

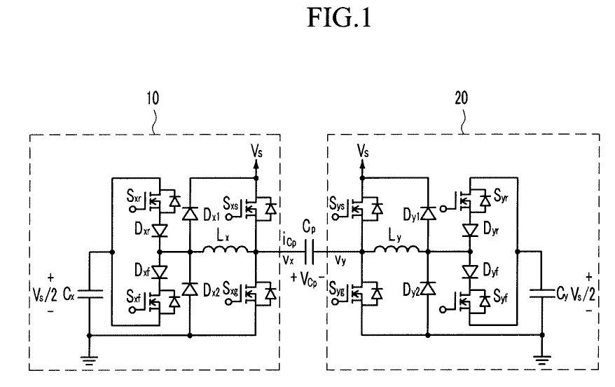

### DETAILED DESCRIPTION

An exemplary embodiment of the present invention will hereinafter be described in detail with reference to the accompanying drawings.

In the following detailed description, only certain exemplary embodiments of the present invention have been shown and described, simply by way of illustration. As those skilled in the art would realize, the described embodiments may be modified in various different ways, all without departing from the spirit or scope of the present invention. Furthermore, in the drawings, in order to clearly describe the present invention, some of the parts not necessary for a complete description of the invention are omitted, and like reference numerals designate like elements throughout the specification.

In the specification, when it is said that any part is “connected” to another part, it means the part is “directly connected” to the other part or is “electrically connected” to the other part with one or more intermediate parts therebetween. Furthermore, when it is said that any part “includes” any constituent element, it means that the part may further include other constituent elements unless described specifically as excluding other constituent elements. Two parts that are directly connected electrically or “electrically connected” to each other may also be referred to as being “electrically coupled”.

In addition, in the present specification, the term “voltage is maintained” includes that although a potential difference between two points changes as time elapses, the change falls within a range that is allowable in design, or the cause of the change resides in parasitic components, which can be disregarded in a design practice by a person of an ordinary skill in the art. Further, since the threshold voltage of semiconductor devices (for example transistors, diodes, and the like) is very low compared with a discharge voltage, the threshold voltage can be assumed to be 0V. Accordingly, the corresponding voltages will be discussed herein in terms of approximate numbers.

A method of driving a plasma display device according to an exemplary embodiment of the present invention will be first described in detail with reference to the drawings.

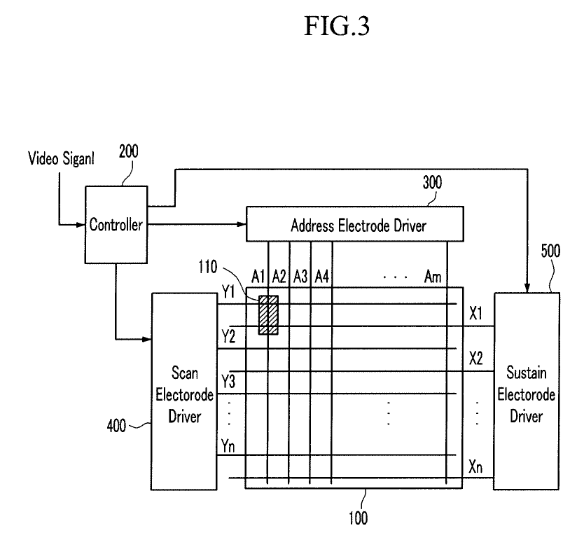

FIG. 3 is a block diagram showing a plasma display device according to an exemplary embodiment of the present invention.

As shown in FIG. 3, the plasma display device according to an exemplary embodiment of the present invention includes a plasma display panel (PDP) 100, a controller 200, an address electrode driver 300, a scan electrode driver 400, and a sustain electrode driver 500.

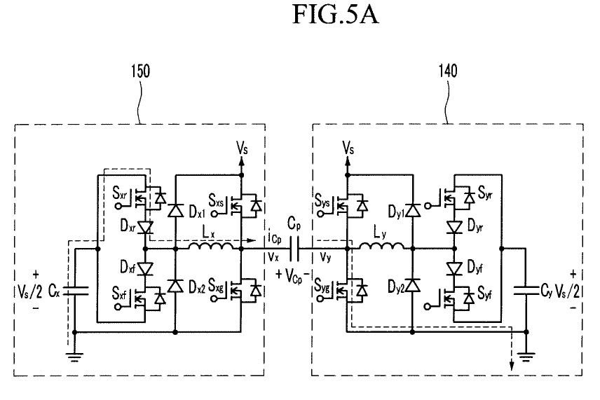

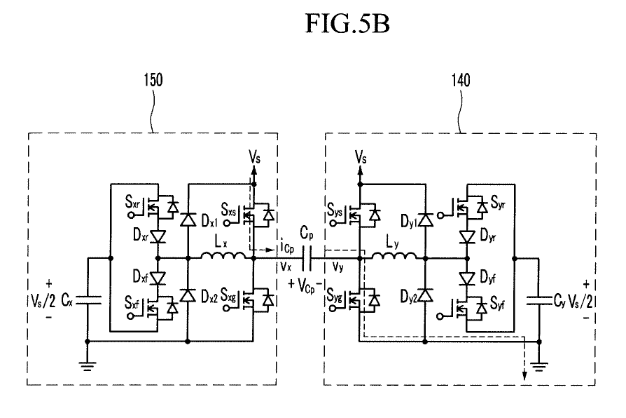

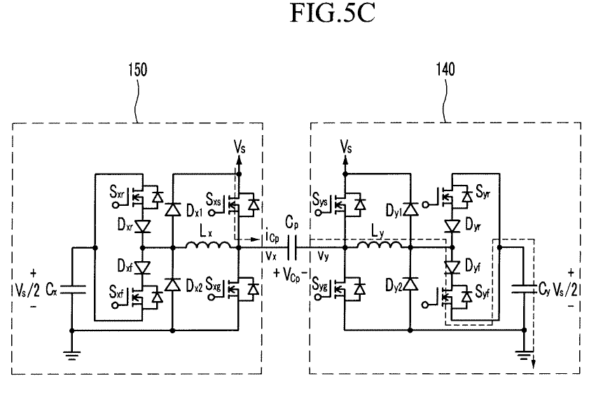

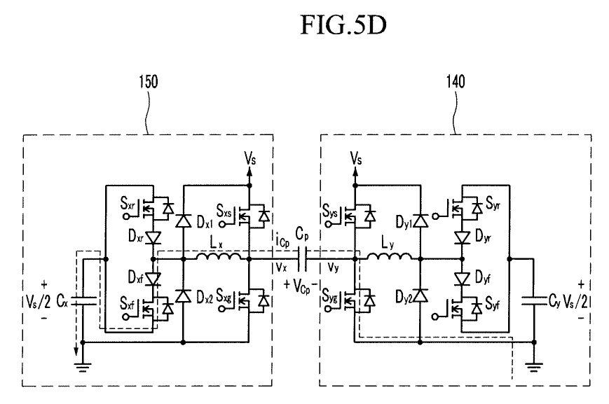

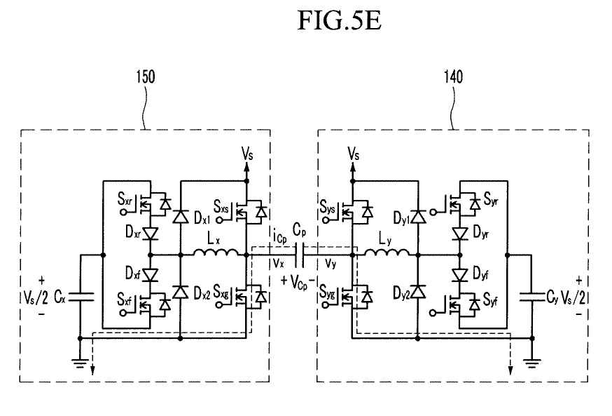

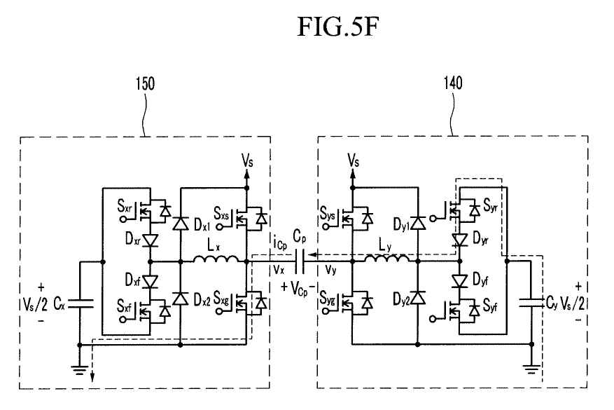

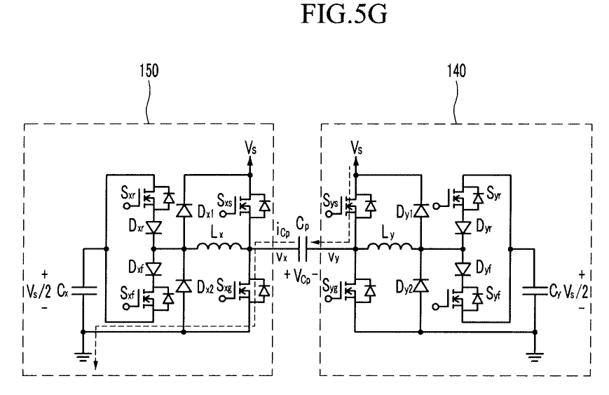

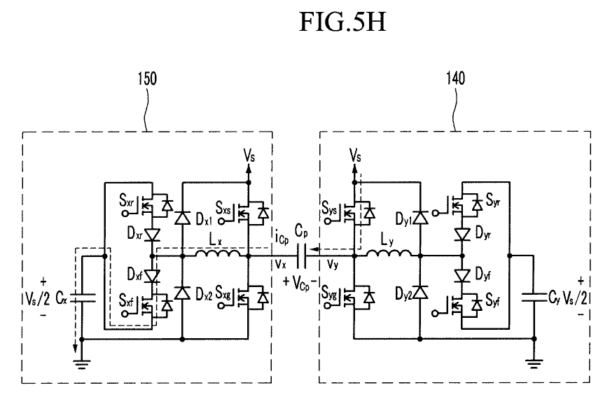

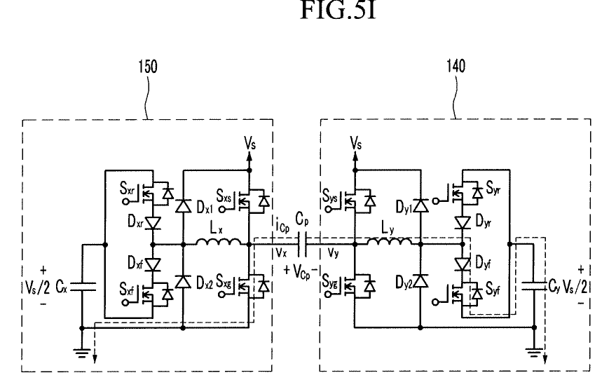

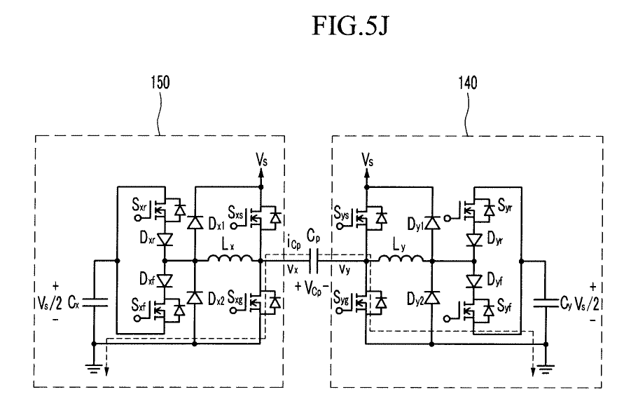

The PDP 100 includes a plurality of address electrodes (hereinafter referred to as “A electrodes”) A1 to Am extending in a column direction, a plurality of sustain electrodes (hereinafter referred to as “X electrodes”) X1 to Xn and scan electrodes (hereinafter referred to as “Y electrodes”) Y1 to Yn that extend in pairs in a row direction. In general, the X electrodes X1 to Xn are formed corresponding to the Y electrodes Y1 to Yn, respectively. The X and Y electrodes may be considered as forming a panel capacitor Cp (as shown in FIGS. 5A-5J, for example) between them. The X electrodes and Y electrodes perform a display operation for displaying an image in the sustain period. The Y electrodes Y1 to Yn and the X electrodes X1 to Xn cross the A electrodes A1 to Am. A discharge space at each crossing region between the A electrodes A1 to Am, and the X and Y electrodes X1 to Xn and Y1 to Yn forms a cell 110. It is to be noted that the construction of the PDP described herein is only an example, and the driving method and driving waveforms as described herein can be applied to any suitable panels having different structures without departing from the spirit and scope of the present invention.

The controller 200 receives an external video signal, and outputs an address electrode driving control signal, a sustain electrode driving control signal and a scan electrode driving control signal. The controller 200 drives one frame that is divided into a plurality of subfields. Each subfield includes an address period and a sustain period.

The address electrode driver 300 applies a driving voltage to the A electrodes A1 to Am in accordance with the driving control signal of the controller 200. The scan electrode driver 400 applies driving voltages to the Y electrodes Y1 to Yn according to the driving control signal from the controller 200. The sustain electrode driver 500 applies driving voltages to the X electrodes X1 to Xn in accordance with the driving control signal from the controller 200.

More specifically, during the address period of each subfield, the address electrode driver 300, the scan electrode driver 400, and the sustain electrode driver 500 select turn-on discharge cells (“on-cells”) and turn-off discharge cells (“off-cells”) of a plurality of discharge cells 110 in a corresponding subfield.

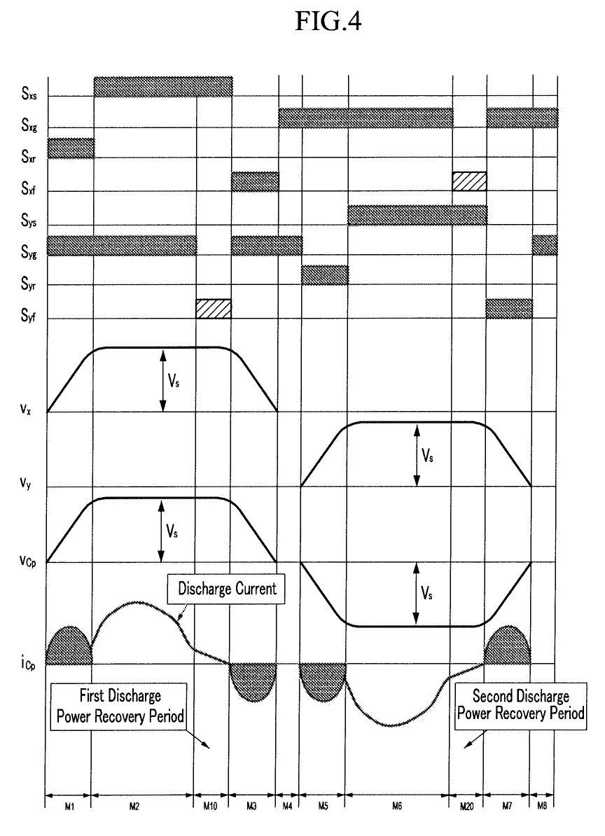

A signal timing diagram and driving of the sustain discharge circuit for supplying a sustain pulse to the X electrodes and the Y electrodes during the sustain period of each subfield will be described in detail below with reference to FIGS. 4 and 5A to 5J.

FIG. 4 is a signal timing diagram of the sustain discharge circuit according to an exemplary embodiment of the present invention, and FIGS. 5A to 5J are circuit diagrams showing the operation of the sustain discharge circuit according to the signal timing of FIG. 4.

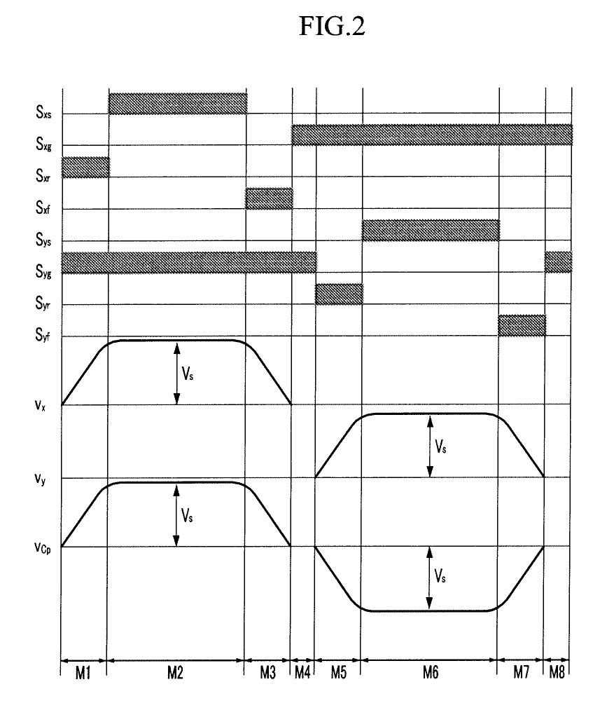

In this case, the signal timing diagram of the sustain discharge circuit according to an exemplary embodiment of the present invention illustrated in FIG. 4 further includes a tenth mode M10 and a twentieth mode M20 in the signal timing diagram of the typical sustain discharge circuit shown in FIG. 2.

Referring to FIGS. 4 and 5A, in the first mode M1, the transistor Sxr and the transistor Syg are turned on, and the remaining transistors Sxf, Sxs, Sxg, Syr, Syf, and Sys are turned off. Due to this, current flows along a path of the capacitor Cx, the transistor Sxr, and the inductor Lx, as shown in FIG. 5A, so that resonance is generated between the inductor Lx and the panel capacitor Cp. Due to the resonance, the voltage Vx of the sustain electrode X rises up to the Vs voltage. Meanwhile, the voltage Vy of the scan electrode Y is maintained at 0V since the transistor Syg is turned on.

In the second mode M2, two transistors Sxs and Syg are turned on, and the remaining transistors Sxr, Sxf, Sxg, Syr, Syf, and Sys are turned off. Due to this, the voltage Vx of the sustain electrode X is maintained at the Vs voltage, as shown in FIG. 5B. At this time, the voltage Vy of the scan electrode Y is maintained at 0V since the transistor Syg is turned on.

In the tenth mode M10, two transistors Sxs and Syf are turned on, and the remaining transistors Sxr, Sxf, Sxg, Syr, Sys, and Syg are turned off. Due to this, as shown in FIG. 5C, the voltage Vx of the sustain electrode X is applied to the sustain discharge circuit 140. Thus, current flows along a path of the inductor Ly, the transistor Syf, and the capacitor Cy, so that resonance is generated between the inductor Ly and the panel capacitor Cp. At this time, the capacitor Cy is charged with discharge current iCp flowing to the capacitor Cy. At this time, the voltage Vx of the sustain electrode X is maintained at the Vs voltage, and the voltage Vy of the scan electrode Y is maintained at 0V. In one exemplary embodiment, each of the capacitors Cx and Cy ha a voltage capacity of Vs/2, which is the voltage across the terminals of the capacitor Cx or Cy when it is charged.

In the third mode M3, two transistors Sxf and Syg are turned on, and the remaining transistors Sxr, Sxs, Sxg, Syr, Syf, and Sys are turned off. Due to this, as shown in FIG. 5D, current flows along a path of the inductor Lx, the transistor Sxf, and the capacitor Cx, so that resonance is generated between the inductor Lx and the panel capacitor Cp. The voltage Vx of the scan electrode X drops from the Vs voltage to 0V, and the voltage Vy of the scan electrode Y is maintained at 0V.

In the fourth mode M4, two transistors; the transistor Sxg and the transistor Syg are turned on, and the remaining transistors Sxr, Sxf, Sxs, Syr, Syf, and Sys are turned off. Due to this, as shown in FIG. 5E, the voltage Vx of the sustain electrode X and the voltage Vy of the scan electrode Y are maintained at 0V.

In the fifth mode M5, two transistors Sxg and Syr are turned on, and the remaining transistors Sxr, Sxf, Sxs, Syf, Sys, and Syg are turned off. Due to this, as shown in FIG. 5F, current flows along a path of the capacitor Cy, the transistor Syr, and the inductor Ly, so that resonance occurs between the inductor Ly and the panel capacitor Cp. Due to the resonance, the voltage Vy of the scan electrode Y rises up to the Vs voltage. At this time, the voltage Vx of the sustain electrode X is maintained at 0V since the transistor Sxg is turned on.

In the sixth mode M6, two transistors Sxg and Sys are turned on, and the remaining transistors Sxr, Sxf, Sxs, Syr, Syf, and Syg are turned off. Due to this, as shown in FIG. 5G, the voltage Vy of the scan electrode Y is maintained at the Vs voltage. At this time, the voltage Vx of the sustain electrode X is maintained at 0V since the transistor Sxg is turned on.

In the twentieth mode M20, two transistors Sxf and Sys are turned on, and the remaining transistors Sxr, Sxs, Sxg, Syr, Syf, and Syg are turned off. Due to this, the voltage Vy of the scan electrode Y is applied to a sustain discharge circuit 150, as shown in FIG. 5H. Thus, current flows along a path of the inductor Lx, the transistor Sxf, and the capacitor Cx, so that resonance occurs between the inductor Lx and the panel capacitor Cp. At this time, the capacitor Cx is charged with discharge current iCp flowing through the capacitor Cx. At this time, the voltage Vy of the scan electrode Y is maintained at the Vs voltage, and the voltage Vx of the sustain electrode X remains at 0V.

In the seventh mode M7, two transistors Sxg and Syf are turned on, and the remaining transistors Sxr, Sxf, Sxs, Syr, Sys, and Syg are tuned off. Due to this, current flows along a path of the inductor Ly, the transistor Syf, and the capacitor Cy, as shown in FIG. 5I. Accordingly, resonance is generated between the inductor Ly and the panel capacitor Cp, and the voltage Vy of the scan electrode Y drops to 0V. Meanwhile, the voltage Vx of the sustain electrode X is maintained at 0V since the transistor Sxg is turned on.

In the eighth mode M8, two transistors Sxg and Syg are turned on, and the remaining transistors Sxr, Sxf, Sxs, Syr, Sys, and Syf are turned off. Due to this, the voltage Vx of the sustain electrode X and the voltage Vy of the scan electrode Y are maintained at 0V, as shown in FIG. 5J.

Thereafter, the above operations of FIGS. 5A to 5J are repeatedly performed to apply sustain pulses, which switch from the Vs voltage to 0V, to the sustain electrode X and the scan electrode Y.

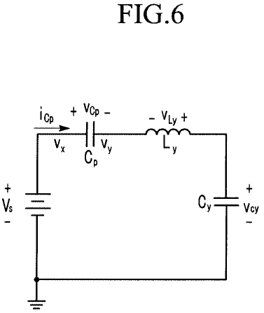

FIG. 6 is an electrical equivalent circuit diagram in a first discharge power recovery period according to an exemplary embodiment of the present invention.

The equivalent circuit shown in FIG. 6 corresponds to the circuit that performs the operation of the tenth mode M10 corresponding to FIG. 5C, of the operation of the sustain discharge circuit according to an exemplary embodiment of the present invention illustrated in FIG. 5.

At this time, voltage across the inductor Ly is proportional to the amount of current per hour that flows through the inductor Ly. It can be expressed in the following equation.

$${v}_{Ly} = {L}_{y} \frac{d {i}_{Cp}}{d t} \qquad Equation 1$$

As shown in FIG. 4, the amount of the discharge current iCp decreases in the tenth mode M10. For this reason,

$$\frac{d {i}_{Cp}}{d t}$$

has a negative value, and therefore the voltage across the inductor Ly has an opposite polarity to that of the voltage across the capacitor Cy, as shown in FIG. 6. Due to this, the voltage Vy of the scan electrode Y, which corresponds to a difference between the voltage Vcy across the capacitor Cy and the voltage V_{Ly} across the inductor Ly, can charge discharge power of the capacitor Cy stably without a significant change in the load voltage in the first discharge power recovery period. Further, in a second discharge power recovery period during the twentieth mode M20, which corresponds to the sustain discharge operation of FIG. 5H, discharge power of the capacitor Cx can be charged stably without a significant change in the sustain voltage Vx in the same manner as the first discharge power recovery period.

While this invention has been described in connection with certain exemplary embodiments, it is to be understood that the invention is not limited to the disclosed embodiments, but, on the contrary, is intended to cover various modifications and equivalent arrangements included within the spirit and scope of the appended claims and their equivalents.

As described above, according to an exemplary embodiment of the present invention, a discharge current, which is consumed during a period where a voltage of a first electrode is increased and maintained through an inductor in a sustain discharge circuit, is induced to flow through a capacitor of an energy recovery circuit connected to a second electrode. Accordingly, discharge power can be recovered without a significant change in a panel voltage and power consumption of a plasma display device can be reduced.

Furthermore, current consumption can be reduced just through efficient control of the operation of a driving circuit without adding an additional circuit. Accordingly, the power consumption can be reduced efficiently in an exemplary embodiment according to the present invention.

What is claimed is:

1. A method of driving a plasma display device including first and second electrodes forming a panel capacitor, a first power supply for supplying a first voltage, a second power supply for supplying a second voltage, first and second inductors having respective first ends connected to the first and second electrodes, respectively, and first and second capacitors electrically coupled to respective second ends of the first and second inductors, respectively, wherein the first and second voltages are alternately applied to the first and second electrodes, the method comprising:
allowing a first current to flow along a first current path including the first capacitor, the first inductor, the panel capacitor, and the second power supply, thereby changing a voltage of the first electrode from the second voltage to the first voltage and maintaining a voltage of the second electrode at the second voltage;
allowing a second current to flow along a second current path including the first power supply, the panel capacitor, and the second power supply, thereby maintaining the voltages of the first and second electrodes at the first and second voltages, respectively;
allowing a third current to flow along a third current path including the first power supply, the panel capacitor, the second inductor and the second capacitor, thereby charging the second capacitor; and
allowing a fourth current to flow along a fourth current path including the panel capacitor, the first inductor and the first capacitor, thereby charging the first capacitor while changing the voltage of the first electrode from the first voltage to the second voltage.

2. The method of claim 1, wherein a voltage capacity of each of the first and second capacitors is a third voltage corresponding to half the difference between the first voltage and the second voltage.

3. The method of claim 1, wherein the first voltage is a positive voltage and the second voltage is a ground voltage.

4. A method of driving a plasma display device including first and second electrodes forming a panel capacitor, first and second charge switches configured to provide charge paths to the first and second electrodes, respectively, first and second discharge switches configured to provide discharge paths to the first and second electrodes, respectively, first and second switches connected to a first power supply and configured to supply a first voltage to the first and second electrodes, respectively, third and fourth switches connected to a second power supply and configured to apply a second voltage to the first and second electrodes, respectively, and first and second capacitors having respective first ends connected to the first charge and discharge switches and the second charge and discharge switches, respectively, and respective second ends connected to the second power supply, wherein the first and second voltages are alternately applied to the first and second electrodes, the method comprising:
turning on the first charge switch and the fourth switch, thereby changing a voltage of the first electrode from the second voltage to the first voltage and maintaining a voltage of the second electrode at the second voltage;
turning off the first charge switch and turning on the first switch, thereby maintaining the voltages of the first and second electrodes at the first and second voltages, respectively; and
turning off the fourth switch and turning on the second discharge switch, thereby charging the second capacitor.

5. The method of claim 4, wherein a voltage capacity of each of the first and second capacitors is a third voltage corresponding to half the difference between the first voltage and the second voltage.

6. The method of claim 4, wherein the first voltage is a positive voltage and the second voltage is a ground voltage.

7. The method of claim 4, further comprising turning off the first switch and the second discharge switch and turning on the first discharge switch and the fourth switch, thereby changing the voltage of the first electrode from the first voltage to the second voltage and maintaining the voltage of the second electrode at the second voltage.

8. The method of claim 7, further comprising turning off the first discharge switch and turning on the third switch, thereby maintaining the voltages of the first and second electrodes at the second voltage.

9. The method of claim 8, further comprising turning off the fourth switch and turning on the second charge switch, thereby changing the voltage of the second electrode from the second voltage to the first voltage and maintaining the voltage of the first electrode at the second voltage.

10. The method of claim 9, further comprising turning off the second charge switch and turning on the second switch, thereby maintaining the voltages of the first and second electrodes at the second and first voltages, respectively.

11. The method of claim 10, further comprising turning off the third switch and turning on the first discharge switch, thereby charging the first capacitor.

12. The method of claim 11, further comprising turning off the first discharge switch and the second switch and turning on the third switch and the second discharge switch, thereby changing the voltage of the second electrode from the first voltage to the second voltage and maintaining the voltage of the first electrode at the second voltage.

13. The method of claim 12, further comprising turning off the second discharge switch and turning on the fourth switch, thereby maintaining the voltages of the first and second electrodes at the second voltage.

14. A method of driving a plasma display device including first and second electrodes forming a panel capacitor, a first power supply for supplying a first voltage to the first electrode, a first switch, an inductor having a first end connected to the second electrode and a second end electrically coupled to a first end of the first switch, a second switch having a first end connected to a contact point between the second electrodes and the first end of the inductor and a second end connected to the second power supply for supplying a second voltage, and a capacitor having a first end connected to a second end of the first switch and a second end connected to the second power supply, the method comprising:
turning off the first switch and turning on the second switch so that current flows along a first current path including the first power supply, the panel capacitor, and the second power supply, thereby maintaining voltages of the first and second electrodes at the first and second voltages, respectively; and
turning on the first switch and turning off the second switch so that current flows along a second current path including the first power supply, the panel capacitor, the inductor, the capacitor, and the second power supply, thereby charging the capacitor.

15. The method of claim 14, wherein a voltage capacity of the capacitor is a third voltage corresponding to half the difference between the first voltage and the second voltage.

16. The method of claim 14, wherein the first voltage is a positive voltage and the second voltage is a ground voltage.
